(19) United States
(12) Patent Application Publication
(10) Pub. No.: US 2012/0169835 A1
(43) Pub. Date: Jul. 5, 2012

(54) MULTI-PARTY AUDIO/VIDEO CONFERENCE SYSTEMS AND METHODS SUPPORTING HETEROGENEOUS ENDPOINTS AND PROGRESSIVE PERSONALIZATION

(76) Inventor: Thomas Woo, Short Hills, NJ (US)

(21) Appl. No.: 12/984,900

(22) Filed: Jan. 5, 2011

(51) Int. Cl. H04N 7/14

(52) U.S. Cl. 348/14.09; 348/E07.084

(57) ABSTRACT

In a method and architecture for multimedia conferencing, each upstream and downstream traffic flow is processed in a custom manner. The custom processing is capable of handling diverse capabilities of end-user devices, diverse access networks over which each conference participant joins the multimedia conference, and/or customizing personalized conference experience for each conference participant.

### BACKGROUND OF THE INVENTION

Existing multimedia conferencing applications support only homogenous endpoints having similar capabilities. In addition, the multimedia conference experience provided to each multimedia conference participant is uniform because each multimedia conference participant's stream goes through the same processing steps.

### SUMMARY OF THE INVENTION

Example embodiments provide a service model for multi-party multimedia conferencing, which extends the capabilities of existing multimedia conferencing systems. Example embodiments enable diverse end-user devices to join a multimedia conference over diverse access networks. Example embodiments also enable conference participants to personalize their own or other participants' multimedia conference experience (e.g., dynamically and/or in real-time during a multimedia conference) using discrete modular multimedia applications and/or modules.

As discussed herein, a multimedia conference experience refers to the experience of the conference participant. Such experience may include the video seen by the conference participant, the audio heard by the conference participant, etc. However, example embodiments are not limited to the examples discussed herein.

At least one example embodiment provides an architecture for a multimedia conferencing system in which each upstream multimedia traffic flow and downstream multimedia traffic flow may be processed independently and in a unique and/or custom manner. The custom processing is performed using applications that may be modularly and/or progressively deployed in the processing path of a conference participant's upstream and/or downstream multimedia traffic path. The use of potentially different applications along each traffic path allow independent, different and/or unique processing for each multimedia traffic flow. The different processing may be useful, for example, in handling the diverse capabilities of end-user devices, diverse access networks over which each conference participant may be joining the multimedia conference and/or in offering custom and/or personalized multimedia conference experience for each conference participant.

The multimedia processing described herein may be implemented using, for example, concept(s) of service chaining as described in, for example, U.S. Pat. No. 7,843,914, entitled “NETWORK SYSTEM HAVING AN EXTENSIBLE FORWARDING PLANE,” the entire contents of which is incorporated herein by reference. With service chaining, each conference participant's traffic flow (upstream and/or downstream) may be directed to a different service chain. In so doing, custom and/or personalized processing may be applied independently and on a per-conference participant basis. Moreover, custom and/or personalized processing may be applied dynamically and/or in real-time during a multimedia conference.

Support for heterogeneous endpoints allows end-user devices having different capabilities to join the same multimedia conference over diverse access networks. Personalization and/or customization of a conference participant's multimedia conference experience allows a unique multimedia conference experience for each conference participant.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention and wherein:

FIG. 1 illustrates a multimedia conferencing system architecture according to an example embodiment.

FIG. 2 is a block diagram illustrating a multimedia conferencing customization unit according to an example embodiment.

FIG. 3 illustrates an example physical implementation of the multimedia conferencing customization unit at a conferencing mixer or other network element according to an example embodiment.

### DETAILED DESCRIPTION OF THE EMBODIMENTS

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. This invention may, however, may be embodied in many alternate forms and should not be construed as limited to only the embodiments set forth herein.

Accordingly, while example embodiments are capable of various modifications and alternative forms, the embodiments are shown by way of example in the drawings and will be described herein in detail. It should be understood, however, that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

In the following description, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at existing network elements (e.g., a conferencing mixer) or existing end-user devices (e.g., mobile devices, laptop computers, desktop computers, etc.). Such existing hardware may include one or more Central Processing Units (CPUs), digital signal processors (DSPs), application-specific-integrated-circuits, field programmable gate arrays (FPGAs) computers or the like.

Although a flow chart may describe the operations as a sequential process, many of the operations may be performed in parallel, concurrently or simultaneously. In addition, the order of the operations may be re-arranged. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

Example embodiments provide a service model for multimedia conferencing, which extends the capabilities of existing multimedia conferencing systems. Example embodiments support diverse end-user devices enabling end-users to join multi-party multimedia conferences over diverse access networks (ANs). As discussed herein, end-users are also referred to as “conference participants.)

Example embodiments also enable conference participants to customize and/or personalize their multimedia conference experience using discrete modular multimedia applications and/or modules.

At least one example embodiment provides an architecture for a multi-party multimedia conferencing system in which each upstream multimedia traffic flow and downstream multimedia traffic flow may be processed independently in a unique and/or custom manner. The unique and/or custom processing is performed using applications that may be modularly and/or progressively deployed in the processing path of a conference participant's upstream and/or downstream multimedia traffic path. The use of potentially different applications along each conference participant's traffic path enables different, independent and/or custom processing for each conference participant's traffic. The custom processing may be useful, for example, in handling capabilities of diverse end-user devices, the diverse access networks over which each conference participant accesses the multimedia conference and/or in offering a more personalized multimedia conference experience for each conference participant.

The multimedia processing described herein may be implemented using, for example, concept(s) of service chaining. With service chaining, each conference participant's traffic flow may be directed to a different service chain, and personalized processing may be applied on a per-conference-participant basis

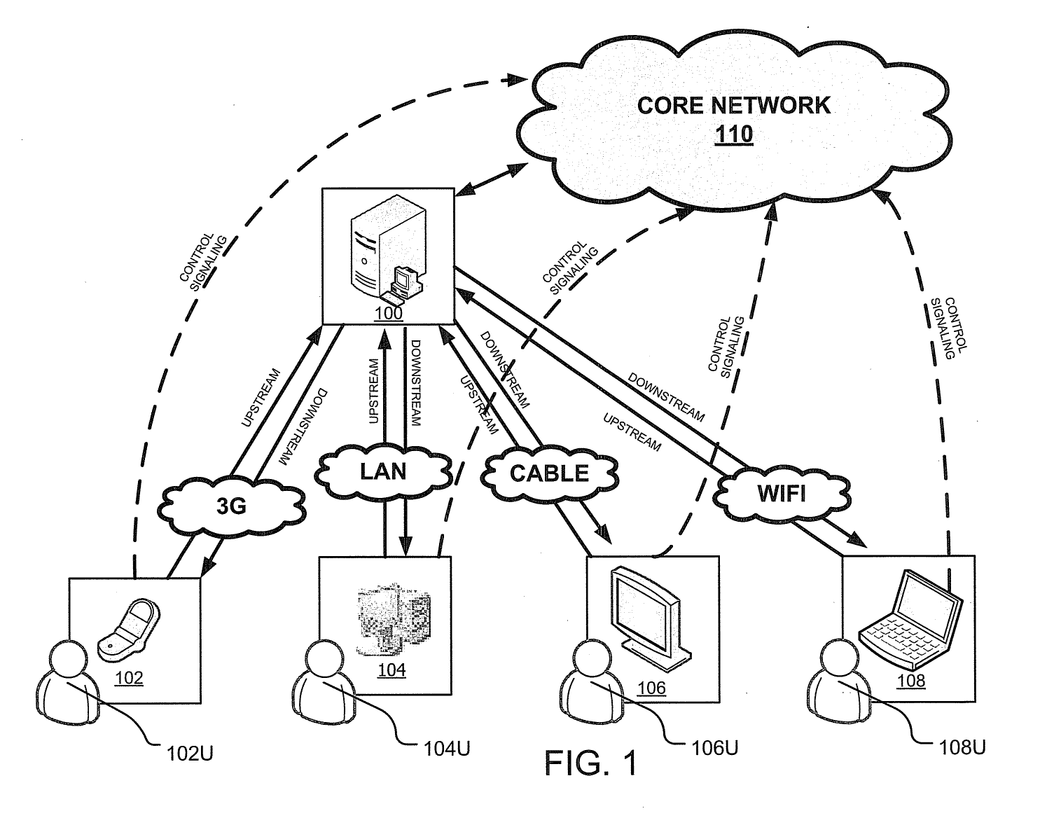

FIG. 1 illustrates a multimedia conferencing system architecture according to an example embodiment.

Referring to FIG. 1, a plurality of end-user devices 102, 104, 106 and 108 are configured to transmit/receive multimedia conference traffic to/from a multimedia conferencing customization unit 100. The multimedia conferencing customization unit 100 may also be referred to as a multimedia conferencing personalization unit. Each end-user device 102 through 108 is operated by and enables a respective end-user 102U through 108U to participate in a multimedia conference.

Example embodiments are discussed herein with regard to the multimedia conferencing customization unit 100 being implemented at a network element such as a conferencing mixer or conferencing mixing server. However, it will be understood that one or more of the components/modules/units/circuits may be implemented at end-user devices. Moreover, the multimedia conferencing customization unit 100 may also be referred to as a multimedia conferencing personalization circuit or device 100.

As discussed herein, multimedia traffic transmitted from one or more of end-user devices 102 through 108 to the multimedia conferencing customization unit 100 is referred to as upstream multimedia traffic or an upstream multimedia traffic flow. Multimedia traffic transmitted from the multimedia conferencing customization unit 100 to one or more of end-user devices 102 through 108 is referred to as downstream multimedia traffic or a downstream multimedia traffic flow.

As also discussed herein, upstream and downstream multimedia traffic may include, for example, audio and/or video traffic, but is not limited thereto.

The end-user devices 102 through 108 may be various devices (both wired and wireless) capable of accessing a multimedia conference via different access networks. In the example shown in FIG. 1, the end-user device 102 is a mobile device (e.g., mobile phone, smartphone, personal digital assistant (PDA), etc.) capable of accessing a multimedia conference via a wireless network (e.g., a 3^{rd} Generation (3G) or 4^{th} Generation (4G) wireless network). The end-user device 104 is shown as a computer capable of accessing a multimedia conference via a wired or wireless local area network (LAN). The end-user device 106 is an Internet television (or other device) capable of accessing a multimedia conference via a cable network. End-user device 108 is a portable or laptop computer (e.g., a laptop, netbook, tablet, etc.) capable of accessing a multimedia conference via a WiFi (or other wireless) network.

Although the end-user devices 102 through 108 are discussed as particular devices accessing particular networks, many of these devices are capable of accessing multiple networks. For example, mobile devices and portable computers (e.g., laptops, netbooks, tablets, etc.) are very often able to access WiFi networks, 3G or 4G networks and/or LANs. It will be understood that the end-user devices 102 through 108 shown in FIG. 1 may participate in multimedia conferences via access networks different from those specifically discussed herein. Thus, example embodiments should not be limited to the particular access network/end-user device combinations discussed herein.

Moreover, it will be understood that the end-user devices 102 through 108 may participate in multimedia conferences by accessing multiple different access networks concurrently and/or simultaneously. In one example, the end-user devices 102 through 108 may spread multimedia data over multiple access networks to achieve load balancing.

Still referring to FIG. 1, when conducting a multimedia conference, the multimedia conferencing customization unit 100 sends and receives multimedia traffic to and from end-user devices 102 through 108. For example, during a multimedia conference, the multimedia conferencing customization unit 100 mixes upstream multimedia traffic flows from each end-user device 102 through 108 and provides/transmits/sends the mixed upstream multimedia traffic flows to each end-user device 102 through 108 as downstream multimedia traffic.

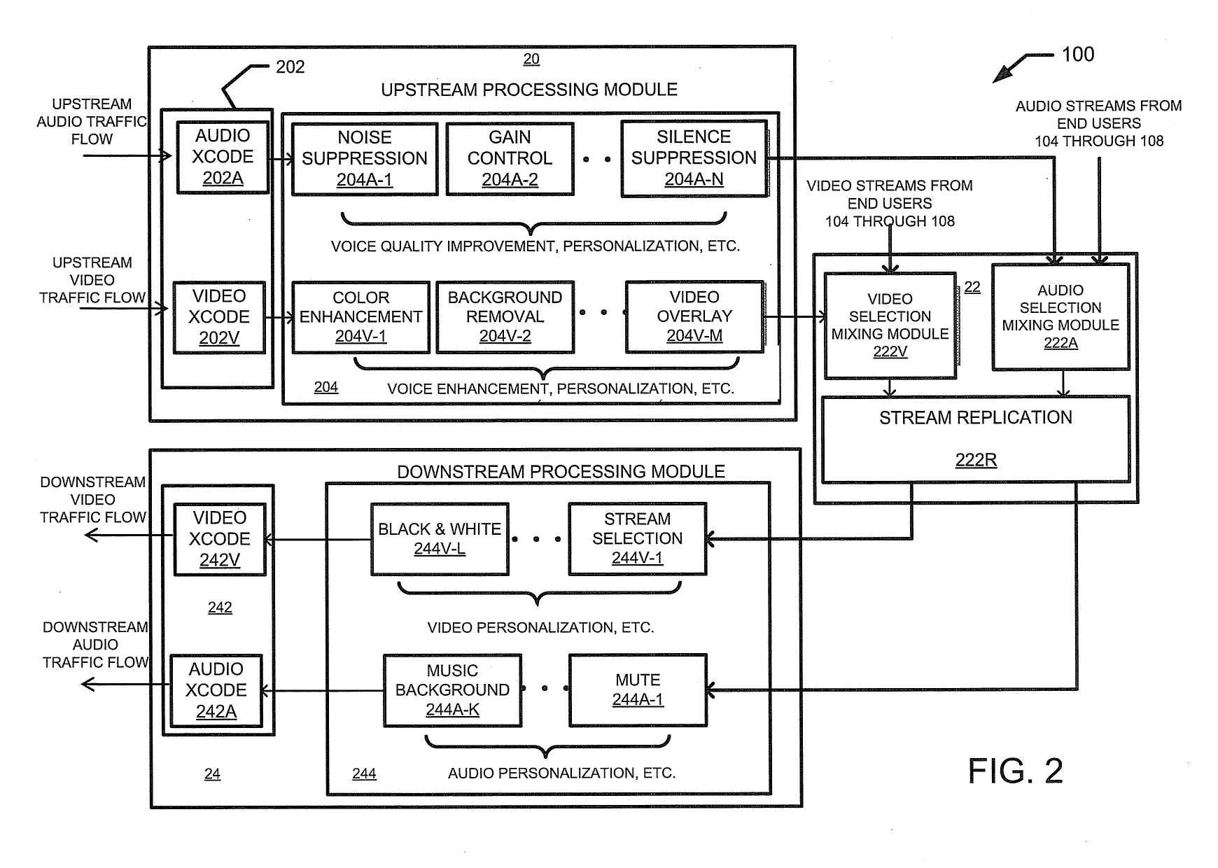

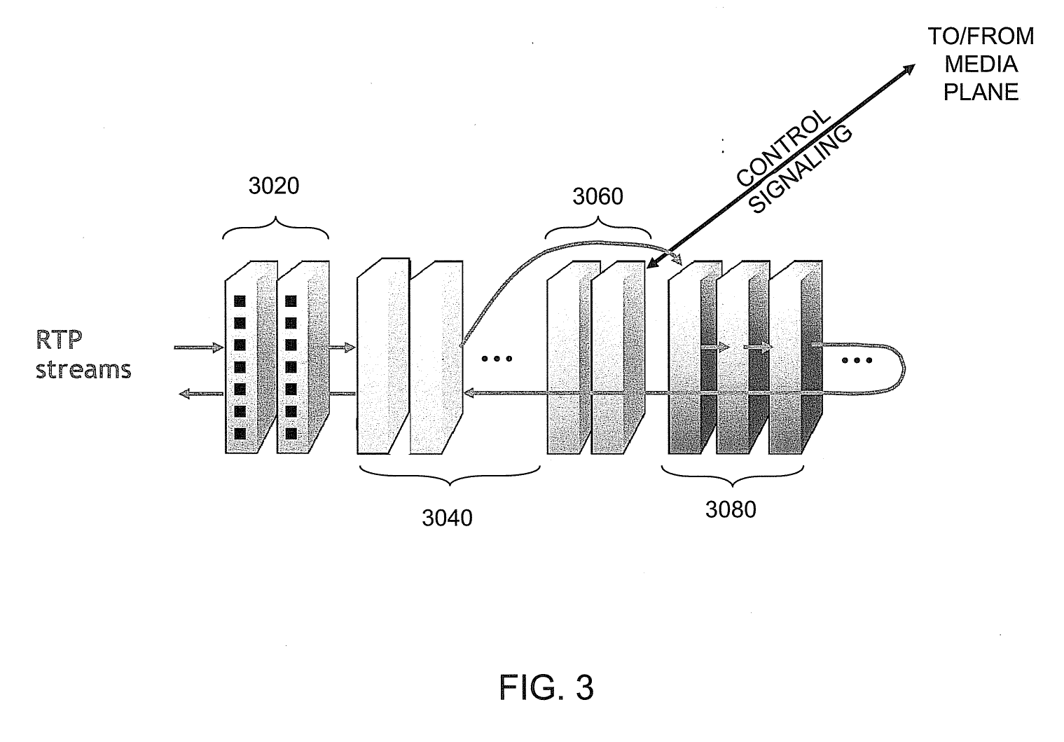

Accordingly, each end-user device 102 through 108 receives the upstream multimedia traffic flows from each other end-user device 102 through 108 participating in the multimedia conference. The multimedia conferencing customization unit 100 will be discussed in more detail later with regard to FIGS. 2 and 3.

Each end-user device 102 through 108 and the multimedia conferencing customization unit 100 also exchange control signaling via a core network 110. In one example, the core network 110 may be an Internet Protocol (IP) multimedia subsystem (IMS) core network. Control signaling includes, for example, identification information for the end-users 102U through 108U or end-user devices 102 through 108 participating in the multimedia conference. Because core networks and control signaling are generally known, a detailed discussion is omitted.

FIG. 2 is a block diagram illustrating an example embodiment of the multimedia conferencing customization unit 100 shown in FIG. 1.

The multimedia conferencing customization unit 100 shown in FIG. 2 will be described with regard to a single upstream multimedia traffic flow transmitted/provided from end-user device 102 and a single (mixed) downstream multimedia traffic flow transmitted to the end-user device 102 during a multimedia conference between end-users 102U through 108U. However, it will be understood that example embodiments are not limited to multimedia conferences including only four participants. Rather, multimedia conferences according to example embodiments may include any number of conference participants.

Referring to FIG. 2, the multimedia conferencing customization unit 100 includes an upstream processing module 20 and a downstream processing module 24. Although discussed herein as modules, the upstream processing module 20 and the downstream processing module 24 may be referred to as units, circuits and/or devices. Other references to elements as modules may also be referred to as units, circuits and/or devices.

The upstream processing module 20 is configured to process the upstream multimedia traffic flow from the end-user device 102 in a unique and/or custom manner, independent of the processing of other multimedia traffic flows, such that the end-user 102U is able to participate in the multimedia conference independent of the end-user device or the access network over which the multimedia conference is being accessed. The processing performed at the upstream processing module 20 also allows customization and/or personalization of the conference experience of the end-user 102U.

As discussed in more detail below, the upstream processing module 20 is configured to transcode and personalize/customize the multimedia conference experience for the other end-users 104U through 108U by processing the upstream multimedia traffic flow from the end-user device 102. In so doing, the end-user 102U is able to dictate at least some aspects of the conference experience of the other end-users 104U through 108U.

Still referring to FIG. 2, the upstream processing module 20 includes an upstream transcoding module 202 and an upstream multimedia conference personalization module 204.

In the example embodiment shown in FIG. 2, the upstream transcoding module 202 includes an upstream audio transcoding module (Audio Xcode) 202A and an upstream video transcoding module (Video Xcode) 202V.

During a multimedia conference, the upstream audio transcoding module 202A transcodes the upstream audio traffic flow from the end-user device 102. Similarly, the upstream video transcoding module 202V transcodes the upstream video traffic flow from the end-user device 102 during the multimedia conference. By transcoding the upstream audio and video traffic flows from the end-user device 102, the upstream transcoding module 202 converts the upstream multimedia traffic flow from the end-user device 102 from a first multimedia traffic format into a second multimedia traffic format. The second multimedia traffic format is different from the first multimedia traffic format and is a format common to the format of upstream multimedia traffic flows from the other end-user devices 104 through 108. In this example, the common format to which the upstream traffic flows are converted may be determined, for example, by a network operator or multimedia conferencing administrator as desired.

As is generally known, transcoding may involve, for example, trans-framing, trans-sizing and trans-rating. Trans-framing includes upscaling/downscaling frame rates of, for example, video streams. By increasing/decreasing the frame rates of the video streams, the smoothness of the video (e.g., the number of frames per second displayed to the conference participant) may be adjusted. Trans-sizing includes upscaling/downscaling resolution of, for example, video streams. Trans-rating includes upscaling/downscaling the bit rates of the audio and/or video streams. In one example, trans-rating may be used to equalize blurriness and/or sharpness of the audio and/or video streams. Because each of trans-framing, trans-sizing and trans-rating is generally known in the art, a detailed discussion is omitted.

The upstream audio transcoding module 202A outputs the transcoded upstream audio traffic flow to the upstream multimedia conference personalization module 204. Similarly, the upstream video transcoding module 202V outputs the transcoded upstream video traffic flow to the upstream multimedia conference personalization module 204.

The upstream multimedia conference personalization module 204 includes a plurality of upstream audio personalization modules 204A-1 through 204A-N and a plurality of upstream video personalization modules 204V-1 through 204V-M. The plurality of upstream audio personalization modules 204A-1 through 204A-N and the plurality of upstream video personalization modules 204V-1 through 204V-M enable the end-user 102U to customize the multimedia conference experience for the other end-users 104U through 108U participating in the multimedia conference. In so doing, the upstream multimedia conference personalization module 204 customizes and/or personalizes the multimedia (e.g., audio and/or video streams) provided to the other end-users 104U through 108U. The upstream audio and video personalization modules 204A-1 through 204A-N and 204V-1 through 204V-M may be implemented by programmable processors (e.g., DSPs, ASICs, FPGAs, etc.) configured as desired by end-users, network operators and/or multimedia conferencing administrators. The programmable processors may be programmed to perform the tasks described herein in any known manner. Because such methods for programming programmable processors is known, a detailed discussion is omitted.

In the specific example shown in FIG. 2, the plurality of upstream audio personalization modules 204A-1 through 204A-N include a noise suppression module 204A-1, a gain control module 204A-2 and a silence suppression module 204A-N.

In this example, the noise suppression module 204A-1 processes the upstream audio traffic flow from end-user device 102 to suppress and/or remove noise (e.g., white noise) thereby improving the audio received by the other conference participants.

The gain control module 204A-2 processes the upstream audio traffic flow from end-user device 102 to control the gain of the audio stream. Because methods for gain control are generally known, a detailed discussion is omitted.

The silence suppression module 204A-N processes the upstream audio traffic flow from the end-user device 102 to suppress silence in the audio stream provided by the end-user device 102. In one example, suppressing silence includes, for example, removing background (e.g., white) noise such that the background noise at the end-user 102U is not transmitted/sent to the other conference participants.

Still referring to FIG. 2, the plurality of upstream video personalization modules 204V-1 through 204V-M include a color enhancement module 204V-1, a background removal module 204V-2 and a video overlay module 204V-M.

In this example, the color enhancement module 204V-1 processes the upstream video traffic flow from the end-user device 102 to provide color enhancement and/or digital color correction of the video stream provided by the end-user device 102. In one example, color enhancement and/or digital color correction may be applied to the entire video picture. In another example, color enhancement and/or digital color correction may be applied to a portion of the video picture. For example, color enhancement and/or digital color correction may be applied to correct facial tones of the end-user 102U such that the end-user 102U appears more appealing.

The background removal module 204V-2 processes the upstream video traffic flow from the end-user device 102 such that the background of the end-user 102U is removed before being provided to the mixing module 22, which is discussed in more detail below. By removing the background of the end-user 102U, the other conference participants 104U through 108U may see the end-user 102U, but not the background location of the end-user 102U.

In another example, the background removal module 204V-2 processes the upstream video traffic flow from the end-user device 102 such that the background of the end-user 102U is replaced (e.g., with a more desirable background picture or scene) before being provided to the mixing module 22.

The video overlay module 204V-M enables the end-user 102U to add an overlay to the video stream provided to the other conference participants 104U through 108U. In one example, the end-user 102U may have his/her name overlay their video stream seen by the other conference participants 104U through 108U. In another example, the end-user 102U may have his/her speech converted to text and then overlayed on his/her video similar to closed-captioned television.

According to at least some example embodiments, the end-user 102U, for example, may configure the programmable processors with desired personalization modules by communicating with the multimedia conference customization unit 100 via control signaling through the core network 100. For example, the end-user device 102 may run a client application (e.g., a multimedia conferencing program, client, application, etc.) having a graphical user interface (GUI) enabling the end-user 102U to cause the end-user device 102 to send and receive control signaling messages/signals to select and configure the personalization modules to be implemented on the programmable processors deployed in the processing path of one or more of the end-users 102U through 108U. The above-discussed common format may be selected in a similar manner through use of the client application and communicated to the multimedia conference customization unit via control signaling through the core network 110. Alternatively, the common format may be designated by a network operator and/or multimedia conference administrator and communicated to the multimedia conference customization unit via control signaling through the core network 110.

Referring still to the block diagram shown in FIG. 2, the upstream processing module 20 outputs the personalized/customized audio and video streams to the mixing module 22.

The mixing module 22 mixes the audio and video streams from the end-user 102U with audio and video streams from the other end-users 104U through 108U participating in the multimedia conference.

As shown in FIG. 2, the mixing module 22 includes an audio selection mixing module 222A and a video selection mixing module 222V.

The audio selection mixing module 222A mixes the audio stream from the upstream processing module 20 with audio streams from the other end-users 104U through 108U participating in the multimedia conference. The audio selection mixing module 222A outputs the mixed audio stream to a stream replicator 222R.

Similarly, the video selection mixing module 222V mixes the video stream from the upstream processing module 20 with video streams from the other end-users 104U through 108U participating in the multimedia conference. The video selection mixing module 222V also outputs the mixed video stream to the stream replicator 222R.

The stream replicator 222R replicates the mixed audio and video streams and outputs the replicated audio and video streams to downstream processing module 24 corresponding to each of the end-users 102 through 108. For the sake of clarity, only a single downstream processing module 24 is shown in FIG. 2. Although each downstream processing module 24 may have different modules, each downstream processing module 24 operates in a similar manner.

The mixing module 22 may control the tiling of the video for end-users participating in the multimedia conference. Although example embodiments are discussed with regard to a common mixing module 22, in alternative example embodiments the multimedia conference customization unit 100 may include a plurality of mixing modules 22. In this example, each of the plurality of mixing modules 22 corresponds to one or more of the end-user devices 102 through 108. By associating each end-user 102U through 108U with a different mixing module 22, each end-user 102U through 108U is able to configure their own tiling scheme for video displayed during a multimedia conference.

Still referring to FIG. 2, the downstream processing module 24 enables the end-user 102U to personalize their own multimedia conference experience with regard to the other end-users 104U through 108U. In one example, the downstream processing module 24 processes downstream multimedia traffic from the other end-users 104U through 108U to customize the multimedia conference experience for the first end-user 102U at the direction of the first end user 102U. As shown in FIG. 2, the downstream processing module 24 includes a downstream multimedia conference personalization module 244 and a downstream transcoding module 242.

The downstream multimedia conference personalization module 244 includes modules similar to the upstream multimedia conference personalization module 204 described above. The particular example shown in FIG. 2 includes a video stream selection module 244V-1 and a black and white video conversion module 244V-L. The downstream multimedia conference personalization module 244 also includes an audio mute module 244A-1 and a background music conversion module 244A-K.

The video stream selection module 244V-1 enables the end-user 102U to select one or more of the video streams from end-users 104U through 108U. The black and white conversion module 244V-L enables the end-user 102U to convert the video of one or more end-users 104U through 108U into black and white, rather than color.

The audio mute module 244A-1 enables the end-user 102U to mute the audio feed from one or more of the end-users 104U through 108U so that the end-user 102U no longer hears the audio of these conference participants. The background music conversion module 244A-K enables the end-user 102U to replace the background music of one or more end-users 104U through 108U with music or other sounds selected by the end-user 102U. The background music conversion module 244A-K also enables the end-user 102U to insert background audio (e.g., music) into the multimedia conference.

Still referring to FIG. 2, the downstream multimedia conference personalization module 24 outputs the personalized audio and video streams to the downstream transcoding module 242.

The downstream transcoding module 242 is similar to the upstream transcoding module 202 described above, and thus, only a brief discussion will be provided for the sake of brevity.

The downstream transcoding module 242 converts the personalized audio and video streams such that the streams are in the proper format for receipt and/or processing by the end-user device 102. In this example, the downstream transcoding module 242 includes a downstream audio transcoding module 242A and a downstream video transcoding module 242V.

The downstream audio transcoding module 242A transcodes the personalized audio stream from the downstream multimedia conference personalization module 244.

The downstream video transcoding module 242V transcodes the personalized video stream from the downstream multimedia conference personalization module 244. The multimedia conferencing customization unit 100 provides/transmits the transcoded downstream video traffic flow and the transcoded downstream audio traffic flow to the end-user device 102.

FIG. 3 illustrates a more physical implementation of the multimedia conferencing customization unit 100 at a conferencing mixer or other network element.

Referring to FIG. 3, a plurality of line service cards (LSCs) 3020 function as a centralized packet input/output. The LSCs 3020 shown in FIG. 3 are configured to receive real-time protocol (RTP) packet streams from conference participants during a multimedia conference.

A plurality of media processing service cards (MPSCs) 3040 are configured to perform the above-described transcoding of upstream and downstream traffic flows received via the LSCs 3020. In one example, the MPSCs 3040 may be high capacity digital signal processing (DSP) blades for audio/video transcoding. Each blade may include about 32 DSPs. The MPSCs 3040 output the transcoded audio and video streams to service cards (SCs) 3080.

The SCs 3080 may be associated with different technologies, and may host high-touch packet processing applications. In one example, the SCs 3080 include DSPs, FPGAs, network processors, etc., each of which is configured to implement the upstream and downstream personalization modules discussed above with regard to FIG. 2. These SCs 3080 may be dynamically reprogrammable such that the modules may be changed according to, for example, market demands. Moreover, the SCs 3080 are shown in FIG. 3 as arranged serially, which enables different media applications to be inserted more easily. However, the SCs 3080 may also be arranged in parallel.

The SCs 3080 may be inserted and/or dropped from a conference participant's processing path dynamically and/or in real-time such that the multimedia conference experience for the conference participant may be customized dynamically and/or in real-time.

Still referring to FIG. 3, Integrated Hub Cards (IHCs) 3060 are configured to perform system control functions such as the above-described control signaling with the media plane in a core network such as an IMS core network.

Although example embodiments are discussed with regard to the multimedia conferencing customization unit being located at a conferencing mixer or other network element, one or more of these components/modules/units/circuits/devices may be implemented within an end-user device. For example, one or more of the upstream personalization module 20 and the downstream personalization module 24 may be located at each end-user device 102 through 108.

Although example embodiments are discussed herein with regard to the end-user 102U and end-user device 102, it will be understood that any and all of the end-users and end-user devices may function in the same manner. For example, each of the end users 104U through 108U (and end-user devices 104 through 108) may customize the multimedia conference experience for any or all of the other end-users participating in the multimedia conference.

Although example embodiments are discussed herein with regard to programmable processors, it will be understood that the modules (e.g., the personalization modules 204A-1 through 204A-N and 204V-1 through 204V-M) discussed herein may also be implemented by specialized hardware.

Example embodiments being thus described, it will be obvious that the same may be varied in many ways. Such variations are not to be regarded as a departure from this disclosure, and all such modifications are intended to be included within the scope of this disclosure.

I claim:

1. A method for conducting a multimedia conference between a plurality of conference participants, the plurality of conference participants including at least a first conference participant and a second conference participant, the method comprising:
processing, at a multimedia conferencing customization unit, at least one multimedia traffic flow associated with at least the first conference participant to customize a multimedia conference experience for at least one of the first and second conference participants; and
conducting, by the multimedia conferencing customization unit, a multimedia conference between the plurality of conference participants according to the at least one processed multimedia traffic flow.

2. The method of claim 1, wherein the at least one multimedia traffic flow is an upstream multimedia traffic flow including upstream multimedia traffic from the first conference participant.

3. The method of claim 2, wherein the processing comprises:
processing the upstream multimedia traffic from the first conference participant to customize a multimedia conference experience for at least the second conference participant.

4. The method of claim 3, wherein the multimedia conference experience is at least one of an audio and video experience for at least the first conference participant.

5. The method of claim 2, further comprising:
transcoding the upstream multimedia traffic flow from a first multimedia traffic flow format to a second multimedia traffic flow format, the second multimedia traffic flow format being different from the first multimedia traffic flow format and being a multimedia traffic flow fog common to at least the second conference participant.

6. The method of claim 1, wherein the multimedia traffic flow is a downstream multimedia traffic flow including multimedia traffic from at least the first and second conference participants.

7. The method of claim 6, wherein the processing comprises:
processing the downstream multimedia traffic from at least the second conference participant to customize the multimedia conference experience for the first conference participant.

8. The method of claim 7, wherein the multimedia conference experience is at least one of an audio and video experience for the first conference participant.

9. The method of claim 6, further comprising:
generating the downstream multimedia traffic flow for the first conference participant by mixing the processed upstream multimedia traffic flow associated with the first conference participant with an upstream multimedia traffic flow associated with at least the second conference participant; and
sending the downstream multimedia traffic flow to the first conference participant.

10. The method of claim 9, further comprising:
replicating the downstream multimedia traffic flow for each of the first and second conference participants; and wherein
the sending step sends the replicated downstream traffic flow to each of the first and second conference participants.

11. The method of claim 1, wherein the processing step processes the multimedia traffic flow independent of a multimedia traffic flow associated with the second conference participant.

12. The method of claim 1, wherein the conducting step comprises:
receiving, at the multimedia conferencing customization unit, the at least one multimedia traffic flow associated with at least the first conference participant; and
sending, by the multimedia conferencing customization unit, the processed at least one multimedia traffic flow to the plurality of conference participants.

13. The method of claim 1, wherein the conducting step comprises:
receiving, at the multimedia conferencing customization unit, the upstream multimedia traffic flow from the first conference; and participant; and
sending, by the multimedia conferencing customization unit, the transcoded downstream multimedia traffic flow to the plurality of heterogeneous conference participants.

14. The method of claim 1, wherein the customization of the multimedia conference experience for at least one of the first and second conference participants is performed at least one of dynamically and in real-time.

15. A method for conducting a multimedia conference between a plurality of heterogeneous conference participants, the plurality of heterogeneous conference participants including at least a first conference participant and a second conference participant, the method comprising:
transcoding, at a multimedia conferencing customization unit, an upstream multimedia traffic flow from the first conference participant from a first multimedia traffic flow format to a second multimedia traffic flow format, the second multimedia traffic flow format being different from the first multimedia traffic flow format and being a multimedia traffic flow format common to at least the second conference participant;
transcoding, by the multimedia conferencing customization unit, a downstream multimedia traffic flow associated with at least the second conference participant from the second multimedia traffic flow format to the first multimedia traffic flow format for transmission to the first conference participant; and
conducting, by the multimedia conferencing customization unit, the multimedia conference between the plurality of heterogeneous conference participants in accordance with the transcoded upstream and downstream multimedia traffic flows.

16. The method of claim 15, wherein the transcoding enables the first and second conference participants to conduct the multimedia conference independent of access network or end-user device being used to access the multimedia conference.

17. The method of claim 15, further comprising:
processing the transcoded upstream multimedia traffic flow to customize the multimedia conference experience for at least the second conference participant.

18. The method of claim 17, wherein the multimedia conference experience is at least one of an audio and video experience for at least the second conference participant.

19. The method of claim 15, wherein the processing comprises:
processing the transcoded downstream multimedia traffic flow to customize the multimedia conference experience for at least the first conference participant.

20. The method of claim 19, wherein the multimedia conference experience is at least one of an audio and video experience for at least the first conference participant.

21. The method of claim 15, further comprising:
generating the downstream multimedia traffic flow by mixing the transcoded upstream multimedia traffic flow with transcoded upstream multimedia traffic flows for others of the plurality of heterogeneous conference participants.

22. The method of claim 21, further comprising:
replicating the downstream multimedia traffic flow for each of the plurality of heterogeneous conference participants;
transcoding, for each of the plurality of heterogeneous conference participants, the downstream multimedia traffic flow into a corresponding multimedia flow format; and
sending each transcoded downstream multimedia traffic flow to a corresponding one of the plurality of heterogeneous conference participants.
